(19) United States
(12) Patent Application Publication
(10) Pub. No.: US 2026/0267129 A1
(43) Pub. Date: Sep. 10, 2026

(54) Light-Field Microscope

(71) Applicant: Carl Zeiss Microscopy GmbH, Jena (DE)

(72) Inventors: Thomas Egloff, Jena (DE); Stanislav Kalinin, Weimar (DE)

(21) Appl. No.: 19/555,093

(22) Filed: Mar. 3, 2026

(30) Foreign Application Priority Data
Mar. 5, 2025 (DE) 10 2025 108 425.4

(51) Int. Cl. G02B 21/36; G02B 3/00; G02B 21/02; G02B 21/06

(52) U.S. Cl. CPC G02B 21/367; G02B 3/0043; G02B 3/0056; G02B 21/02; G02B 21/06

(57) ABSTRACT

A light-field microscope having a light source an illumination beam path for guiding illumination light into a sample region, a two-dimensionally spatially resolving detector for detecting detection light coming from a sample, a detection beam path with a multi-lens array for guiding the detection light, a stop device for preventing crosstalk between detection paths belonging to different lenses of the multi-lens array, and a control unit for evaluating measurement data from the detector. Each lens of the multi-lens array belongs to exactly one of at least two lens groups, each lens group has at least three lenses, detector-side focal points of lenses of the same lens group lie at the same position in an axial direction relative to a sensor surface of the detector, detector-side focal points of lenses from different lens groups lie at different positions in the axial direction, and the lenses from each lens group are arranged distributed over a surface of the multi-lens array.

The current application claims the benefit of German Patent Application No. 10 2025 108 425.4, filed on 5 Mar. 2025, which is hereby incorporated by reference.

The present invention relates to a light-field microscope according to the preamble of claim 1.

A generic light-field microscope has at least the following constituent parts: a light source for providing illumination light, an illumination beam path for guiding the illumination light into a sample region, a two-dimensionally spatially resolving detector for detecting detection light coming from a sample in the sample region, a detection beam path with a microscope objective and a multi-lens array for guiding the detection light to the detector, a stop device for preventing crosstalk between detection paths belonging to different lenses of the multi-lens array, and a control unit for evaluating measurement data from the detector.

DE 10 2022 128 078 A1 discloses a generic light-field microscope.

In fluorescence microscopy, samples that have been prepared with fluorescent dyes or are self-fluorescent can be recorded in three dimensions. In commercially available microscopes, at least one dimension is scanned and thus captured sequentially over time for the three-dimensional image recording. Examples thereof include wide-field microscopy and structured illumination microscopy (SIM), where scanning is performed in the axial direction, and light sheet microscopy, where scanning is performed in a lateral direction. With the laser scanning microscope (LSM), the focus volume of the illumination light has to be scanned through the sample even in all three spatial dimensions.

Fanglin Linda Liu, et al., [2], describe a method in which the images generated by the individual lenses of a multi-lens array overlap in a sensor plane of a detector. The data evaluation is comparatively complex in such arrangements.

A further aspect that should always be kept in mind during microscopy is the load on a sample due to irradiation with the illumination light. This is influenced by the fact that the dyes used may undergo bleaching, and also the fact that the samples to be examined may be inherently light-sensitive. In the microscopy methods indicated above, the sample is illuminated in the scanned direction at all times, but the fluorescent signal is not used at all times, except for light sheet microscopy. The amount of light that can be introduced into a sample in a specific time without bleaching of fluorescent dyes and/or damage to the sample itself is limited. This likewise constitutes a limitation for the existing methods, which has been able to be avoided hitherto only for light sheet microscopes.

One possibility for recording three-dimensional information about a sample in parallel over time is light-field microscopy. In that case, the spatial distribution and the angular distribution of the light from the object space are detected in parallel. In a first variant, an angular distribution of the detected light is acquired for each object point in each case for a discrete number of angles. This variant is referred to as spatial domain light-field microscopy. In another variant of light-field microscopy, an object is captured in each case from a discrete number of viewing directions. This variant is referred to as Fourier light-field microscopy. In addition, disclosure under the keyword term “Diffusor Scope” involves superimposing different viewing directions or the angular distribution and location information, [2].

One problem with light-field microscopes is that an improvement in the lateral resolution and thus the reconstructable image quality in all three spatial coordinates leads to a deterioration in a usable axial range and thus to a reduced depth of field of the light-field microscope.

The following relationships apply to a Fourier light-field microscope:

$${x}_{res \_ limit} ∝ 1 / n$$

$${z}_{range} ∝ {n}^{2}$$

in which
x_{res_limit} is the resolution in the x-direction and thus in a lateral direction,
z_{range} is the axial depth of field and
n is the number of lenses of the multi-lens array along the diameter of the multi-lens array, which is related to the total number N of lenses as follows:

$$n ∝ 1 + \sqrt{( N - 1 )}$$

The lateral resolution is accordingly inversely proportional to the number of lenses of the multi-lens array along the diameter, and the axial depth of field is proportional to the square of the number of lenses of the multi-lens array along the diameter. The axial resolution of a light-field microscope is proportional to the lateral resolution during reconstruction. The same behaviour applies to the contrast and image quality of the reconstruction. These limitations apply to a spatial domain light-field microscope in an equivalent form.

An object of the invention can be considered that of specifying a light-field microscope in which improvements in respect of lateral and axial resolution are achieved.

This object is achieved by the light-field microscope having the features of claim 1.

According to the invention, the light-field microscope of the type indicated above is developed in that each lens of the multi-lens array belongs to exactly one of at least two lens groups, in that each lens group has at least three lenses, in that detector-side focal points of lenses of the same lens group lie at the same position in an axial direction relative to a sensor surface of the detector at the location of the relevant lens, in that detector-side focal points of lenses from different lens groups lie at different positions in the axial direction relative to the sensor surface of the detector at the location of the relevant lens, and in that the lenses from each lens group are arranged distributed over a surface of the multi-lens array.

Preferred exemplary embodiments of the light-field microscope according to the invention will be explained below, in particular in association with the dependent claims and the figures.

The light source can be implemented by any light source capable of supplying the illumination light with a desired spectral composition and with a suitable intensity. For example, the light source can be a laser, a plurality of lasers, an LED, an LED module or a combination of these components or of a plurality of these components. The illumination light can be coherent or at least partially coherent illumination light.

The illumination light is electromagnetic radiation, in particular in the visible spectral range and in adjoining ranges. The illumination light can also be referred to as excitation light; these two terms are used synonymously for the most part in this description.

The term illumination beam path denotes in particular beam-guiding and beam-modifying components, e.g. lenses, mirrors, prisms, gratings, filters, stops, beam splitters, by means of which and via which the illumination light is guided from the light source to the sample to be examined. The only demand placed on the contrast-providing principle by the present invention is that the sample emits detection light as a consequence of the irradiation by the excitation light.

The term sample region or sample space denotes the spatial region in which a sample to be examined can be arranged. In typical embodiments, a sample, e.g. by means of a sample holder or a sample frame, can be positioned or secured on an x-y stage which is adjustable in lateral directions with respect to an optical axis. A z-drive can be present to modify the distance between the sample stage and a microscope objective.

In principle, the sample can be any kind of sample. The light-field microscope according to the invention and the method according to the invention are suitable for examining biological samples in particular.

Detection light is light emitted by the sample to be examined, in particular as a consequence of said sample being irradiated by the illumination light. In order for the light to be able to be referred to as detection light, it is only necessary that the light is emitted by the illuminated sample or that in any case it comes from the illuminated sample. The detection light may also be referred to as emission light. The detection light may also be deflected, scattered or reflected excitation light. Typically, the detection light is fluorescence which the sample, in particular dye molecules present there, emits or emit as a consequence of being irradiated with the illumination light.

The two-dimensionally spatially resolving detector can comprise one or more of the following elements or following components: CCD element, CMOS element, SPAD element. A sensor surface of the detector is that plane in which the detection light is detected.

The term detection beam path denotes in particular beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective is part of the detection beam path. The microscope objective of the detection beam path can also be part of the illumination beam path. The illumination beam path can also have a separate microscope objective.

The optical axis of the detection beam path is given by the optical axis of the microscope objective. Commercially available microscope objectives can be used, in principle.

The multi-lens array serves to image light emitted by a sample onto the detector. The term multi-lens array denotes an arrangement of a plurality of lenses in a plane, wherein the optical axes of the individual lenses are generally parallel to one another. However, that is not absolutely necessary. The optical axes of the lenses of the multi-lens array can run transversely, in particular perpendicularly, to a sensor surface of the detector. The individual lenses can in particular each have the same size, but that is not absolutely necessary either. The lenses of the multi-lens array can be microlenses, in particular, and the multi-lens array can also be referred to as a microlens array.

A lens group consists of at least three lenses of the multi-lens array that are similar in a qualified manner. That will be described in even more specific detail below.

The term detector-side focal point of a particular lens of the multi-lens array is taken to mean that point whose distance from the relevant lens is equal to the focal length of this lens. The location of a lens relative to the sensor surface of the detector is taken to mean that location at which the optical axis of the relevant lens intersects the sensor surface of the detector.

The term surface of the multi-lens array is taken to mean that surface over which the multi-lens array extends transversely to the optical axes of the individual lenses of the multi-lens array.

A partial image denotes an individual image generated by an individual lens of the multi-lens array in the sensor plane of the detector. The totality of the images generated by lenses of the multi-lens array in the sensor plane of the detector is referred to as an image data set. Thus, each image data set of the sample consists of a set of partial images.

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

The stop device is used to prevent crosstalk between detection paths belonging to different lenses of the multi-lens array.

In a first preferred exemplary embodiment of the light-field microscope according to the invention, the stop device has a field stop arranged in an intermediate image plane. This field stop limits the size of the partial images in the sensor plane and is expediently dimensioned such that the partial images belonging to the individual lenses of the multi-lens array do not overlap on the detector. A prerequisite for this is that an intermediate image plane is present in the detection beam path, in which intermediate image plane the field stop can be arranged.

In an alternative configuration, the stop device can have a stop structure having a plurality of tubular stops, which is arranged between the multi-lens array and the detector. This stop structure, as with a field stop, ensures that the partial images belonging to the individual lenses of the multi-lens array do not overlap on the detector. This variant can be used in particular if, in the detection beam path, there is no intermediate image plane in which a field stop can be arranged.

The term control unit denotes all hardware and software components which interact with the components of the light-field microscope according to the invention for the intended function thereof. In particular, the control unit can comprise a computing device, for example a PC, and a camera controller. The computer resources of the control unit can be distributed among a plurality of computers and optionally a computer network, in particular also via the Internet. The control unit can have in particular customary operating devices and peripherals, such as mouse, keyboard, screen, storage media, joystick, Internet connection. The control unit can in particular read the image data from the detector and can also be configured and serve to control the light source.

A first essential concept of the present invention can firstly be considered that of subdividing the lenses of the multi-lens array into lens groups, each consisting of at least three lenses, wherein the focal points of lenses of a lens group are arranged identically or at any rate sufficiently similarly in each case with respect to a sensor plane of the detector. Focal points of lenses from different lens groups are each arranged differently with respect to the sensor plane. Examples of how that can be specifically realized are described below.

A further essential concept of the present invention is then that the lenses from each individual lens group are arranged distributed over the surface of the multi-lens array. This feature has the effect that an image stack can in each case be reconstructed from the partial images belonging to the lenses of a specific lens group.

A first important advantage in comparison with the prior art is that the usable axial range in the sample can be increased with high lateral and axial resolution at the same time.

A further advantage is the reduced computation artefacts in comparison with the prior art. This is achieved by virtue of less defocus-based blur, and sharp imaging of identical z-planes.

What is additionally advantageous is that, in contrast to the prior art, in particular to the DiffuserScope approach [2], a separation of information from different viewing directions and thus a poorer performance, especially with typical densely labelled biological samples, can be avoided.

Finally, what is also advantageous is that, depending on the arrangement of the lenses in the individual lens groups, symmetries of this arrangement can be taken into account in the reconstruction of the image stacks, whereby the reconstruction can be very greatly accelerated.

Finally, the light-field microscope according to the invention makes it possible to increase the robustness vis-à-vis deviations of the point spread function (PSF) as a result of changes in the refractive index, for example in the sample, in particular in comparison with the DiffuserScope approach.

In principle, in the light-field microscope according to the invention, the multi-lens array can be arranged in an intermediate image plane or in the vicinity of an intermediate image plane. This results in a spatial domain light-field microscope. Expediently, the detection beam path then has a tube lens for generating an intermediate image plane.

Alternatively, it is also possible for the multi-lens array to be arranged in the back focal plane of the microscope objective or in the vicinity of said plane. In one preferred exemplary embodiment, the multi-lens array is arranged in a plane optically conjugate to the back focal plane of the microscope objective, thus in a pupil plane or aperture stop plane, or in the vicinity of a pupil plane. These variants result in a Fourier light-field microscope.

Expediently, the detection beam path then has a relay optics unit for generating a pupil plane, that is to say a plane optically conjugate to a back focal plane of the microscope objective. The relay optics unit can have a tube lens and a further lens.

The number of lenses in the multi-lens array is not limited, in principle. Preferably, the multi-lens array can have at least seven and up to 91 lenses. The lenses of the multi-lens array can be located for example on a hexagonal grid or on a square grid.

In principle, for the realization of the invention, it is only necessary that the lenses of the multi-lens array are subdivided into at least two lens groups. In one advantageous configuration of the light-field microscope according to the invention, the multi-lens array has three to 25 and preferably three to five lens groups.

In principle, it is possible for the lens groups to have a different number of lenses.

However, it is advantageous, especially with regard to the reconstruction algorithms, if all lens groups have the same number or approximately the same number of lenses. In exemplary embodiments of the invention, the number of lenses in the individual lens groups differs by a maximum of 3, preferably by a maximum of 2, and particularly preferably by a maximum of 1.

The detector can have a plane sensor surface. All lenses of the multi-lens array can be arranged at the same distance from the sensor surface of the detector. In order to realize the feature according to the invention of the respective position of the focal points of lenses of a lens group and the focal points of lenses from different lens groups with respect to the sensor plane of the detector, then all lenses of the same lens group each have the same nominal focal length and the lenses from different lens groups each have a different nominal focal length.

If two lenses of the multi-lens array have the same nominal focal length, the focal lengths of these lenses differ only owing to production engineering reasons.

An interval δf in which the focal lengths of the lenses of a lens group are located preferably satisfies the inequality

$$δ f < 1. \cdot λ \cdot {F}^{2}$$

and/or an interval Δf in which the focal lengths of all lenses of the multi-lens array are located preferably satisfies the inequality

$$0.3 \cdot λ \cdot {F}^{2} < Δ f < 1.5 \cdot λ \cdot {F}^{2}$$

in which
λ is the wavelength of the detection light,
F is the f-number F=f₀/Ø,
f₀ is the average focal length of the lenses of the multi-lens array, and
Ø is the diameter of the multi-lens array.

However, it is also possible for the lenses of the multi-lens array all to have the same nominal focal length.

The feature according to the invention of the respective position of the focal points of lenses of a lens group and the focal points of lenses from different lens groups with respect to the sensor plane of the detector can then be realized in a first variant by virtue of the fact that lenses of the same lens group are each arranged at the same distance from the sensor surface of the detector and that lenses belonging to different lens groups are arranged at respectively different distances from the sensor surface of the detector.

Supplementarily or alternatively, it is also possible for the sensor surface of the detector to have a plurality of steps, wherein the steps at locations where lenses of the same lens group are located each have the same axial step height and wherein the steps at locations where lenses from different lens groups are located each have a different axial step height. In this way, too, the feature according to the invention of the respective position of the focal points of lenses of a lens group and the focal points of lenses from different lens groups with respect to the sensor plane of the detector can be realized.

The feature according to the invention that the lenses from each lens group are arranged distributed over a surface of the multi-lens array can mean in particular that the positions of the lenses of a lens group do not all lie on the same straight line and that, in other words, the positions of lenses of a lens group span a plane.

Generally, the lenses from each lens group can be arranged distributed over the surface of the multi-lens array in such a way that a largest possible region of the multi-lens array is covered by each lens group. In one preferred variant, the surface area resulting from linking the positions of lenses of a lens group which are located at the outer region relative to the centre of the multi-lens array is at least 40 percent, preferably at least 60 percent, and particularly preferably at least 80 percent, of that surface area which results from linking the positions of the lenses located at the outer edge of the multi-lens array. The area resulting from linking the positions of lenses of a lens group which are located at the outer region relative to the centre of the multi-lens array can be, for example, a triangle, a quadrilateral, in particular a square or a rectangle, a pentagon or a polygon having a higher number of vertices. The position of a lens is taken to mean the intersection point between the optical axis of this lens and a plane perpendicular to the optical axis of the detection beam path at the location of the multi-lens array. The lenses of a lens group which are located at the outer region relative to the centre of the multi-lens array can be located in particular on an outer ring of lenses or on that ring of lenses which is inwardly, in particular directly, adjacent to the outer ring. The arrangement of the lenses in rings around a centre is described even more thoroughly further below.

In one preferred exemplary embodiment, the surface of the multi-lens array is subdividable into a number of at least three, in particular three to six, equally sized sectors which in an azimuthal direction are adjacent and non-overlapping, in such a way that at least one lens from each lens group, and in particular the same number of lenses from each lens group, is arranged in each of these sectors. For example, the sectors can be four quadrants and the criterion established here is then that at least one lens from each lens group and in particular the same number of lenses from each lens group is arranged in each of the quadrants.

Alternatively or supplementarily, the surface of the multi-lens array can be subdividable into a central circular region and at least two, in particular three to six, adjacent and non-overlapping concentric annular regions each having the same radial extent, in such a way that at least one lens from each lens group, and in particular the same number of lenses from each lens group, is arranged in each of these regions.

The feature of the distribution of the lenses from each lens group over the surface of the multi-lens array can alternatively or supplementarily also include the fact that each lens of the multi-lens array has a maximum of one directly adjacent lens belonging to the same lens group.

The feature of the distribution of the lenses from each lens group over the surface of the multi-lens array can then also include the fact that the lenses of a lens group are distributed uniformly over the surface of the multi-lens array.

Preferably, the lenses from at least one lens group or the lenses from a plurality or each of the lens groups can be distributed over the surface of the multi-lens array in such a way that the distances between these lenses are maximal, in particular when realized simultaneously with and taking account of the feature that the lenses of the multi-lens array are arranged on a grid, for example a hexagonal or square grid.

A further preferred exemplary embodiment of the light-field microscope according to the invention is distinguished by the fact that the multi-lens array has a central region formed from one lens or from three or four lenses, and at least one ring of lenses that completely encloses the central region. In particular, the multi-lens array can have a plurality of rings of lenses, each concentrically enclosing the central region. Preferably, each further radially outwardly following ring completely encloses a respectively preceding inner ring. The central region and the individual rings can be disjoint, in particular, so that each of the lenses of the multi-lens array belongs to exactly one of the rings. The multi-lens array can have two to nine, preferably two to four, rings.

With regard to the distribution of the lenses over the surface of the multi-lens array, it can also be advantageous if each ring has at least one lens from each lens group. Supplementarily or alternatively, the lenses of a lens group can be arranged in each of the rings at a maximum distance in a circumferential direction of the ring. Supplementarily or alternatively, each ring can have the same number of lenses from each lens group.

In a further advantageous variant, the lenses of at least one lens group, preferably from a plurality of lens groups or each lens group, are arranged on a sub-grid of that grid on which the lenses of the multi-lens array are arranged.

A further advantageous configuration of the light-field microscope according to the invention is distinguished by the fact that the control unit is configured to correct image distortions during the reconstruction of an image stack from a measured image data set, said image distortions being caused by the different positions of the focal points of lenses from different lens groups in the axial direction relative to the sensor surface of the detector at the location of the relevant lens. In this variant, the advantages of the light-field microscope according to the invention, namely the increased lateral and axial resolution and the increase in the depth of field, can be especially achieved.

Further advantages and features of exemplary embodiments of the light-field microscope according to the invention are explained below in association with the figures, in which:

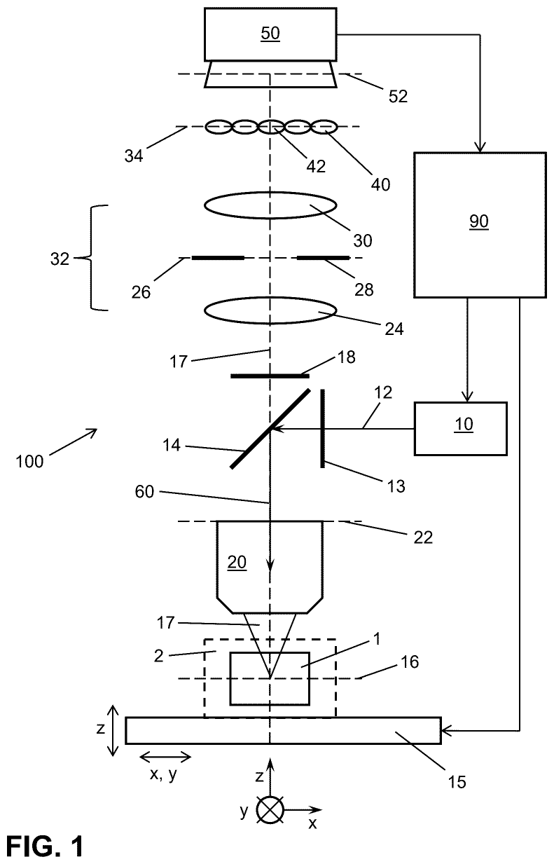

FIG. 1: shows a schematic illustration of one exemplary embodiment of a light-field microscope according to the invention;

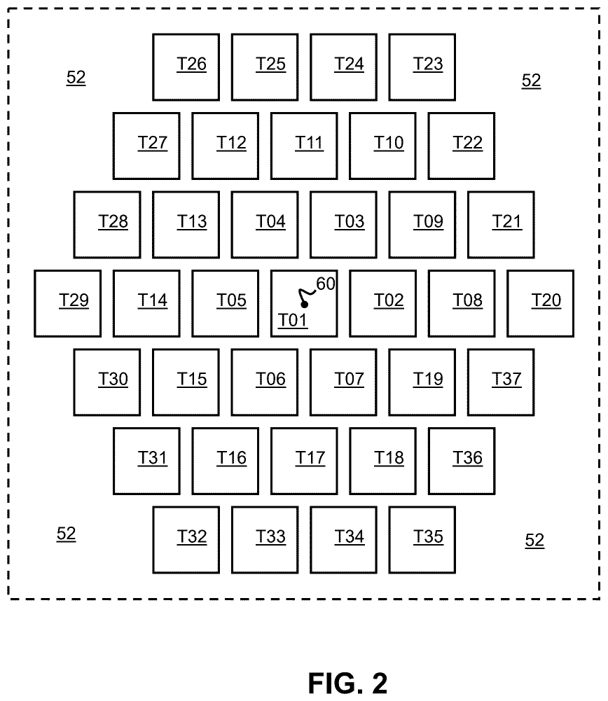

FIG. 2: shows a schematic illustration of the arrangement of partial images on a sensor surface of a detector, which form an image data set recorded using the light-field microscope according to the invention;

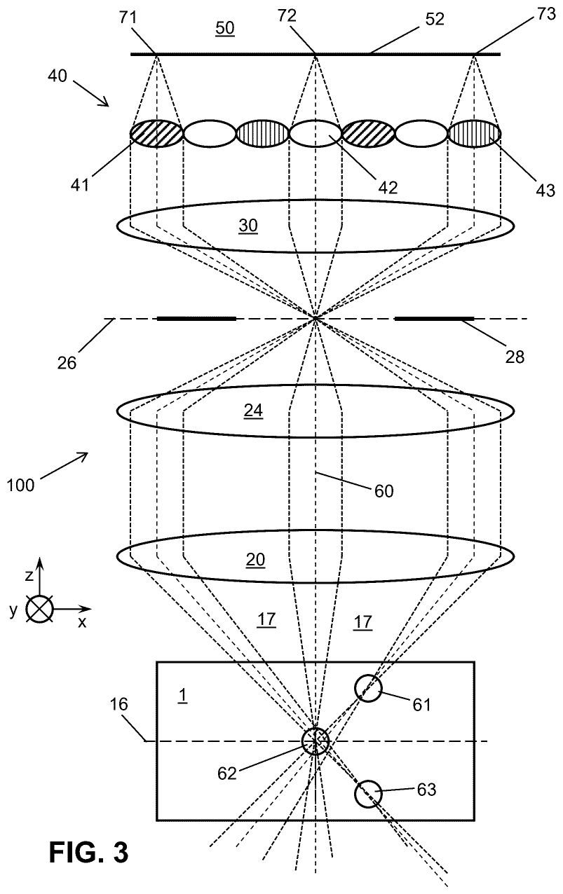

FIG. 3: shows a schematic illustration of beam paths in the exemplary embodiment of the light-field microscope according to the invention from FIG. 1;

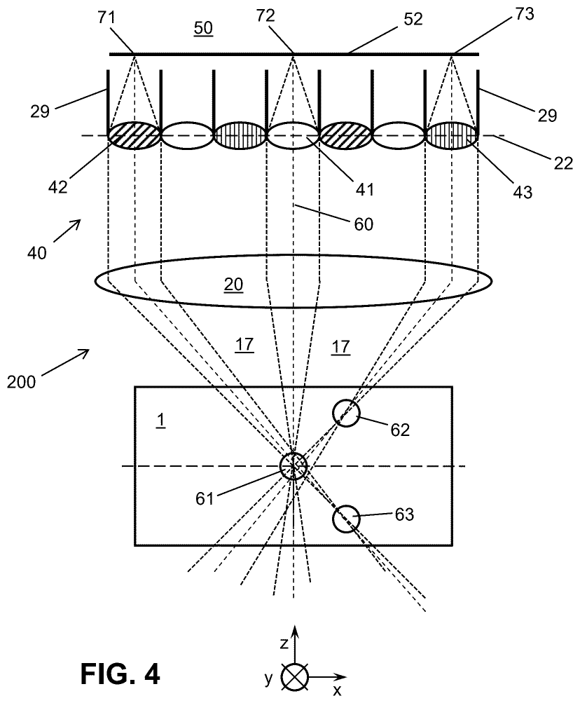

FIG. 4: shows a schematic illustration of beam paths in a further exemplary embodiment of the light-field microscope according to the invention;

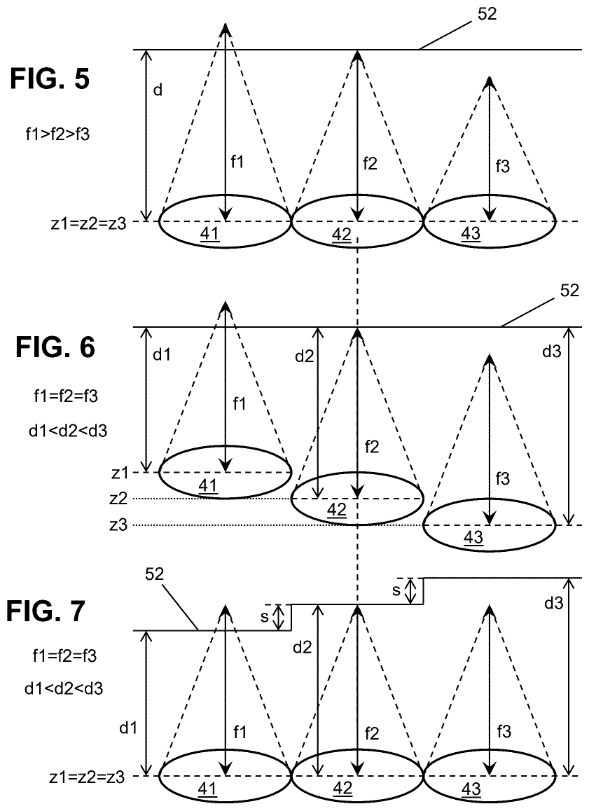

FIG. 5: shows a schematic illustration of a first exemplary embodiment for realizing the different positions of detector-side focal points of lenses from different lens groups in the axial direction relative to the sensor surface of the detector;

FIG. 6: shows a schematic illustration of a second exemplary embodiment for realizing the different positions of detector-side focal points of lenses from different lens groups in the axial direction relative to the sensor surface of the detector;

FIG. 7: shows a schematic illustration of a third exemplary embodiment for realizing the different positions of detector-side focal points of lenses from different lens groups in the axial direction relative to the sensor surface of the detector; and

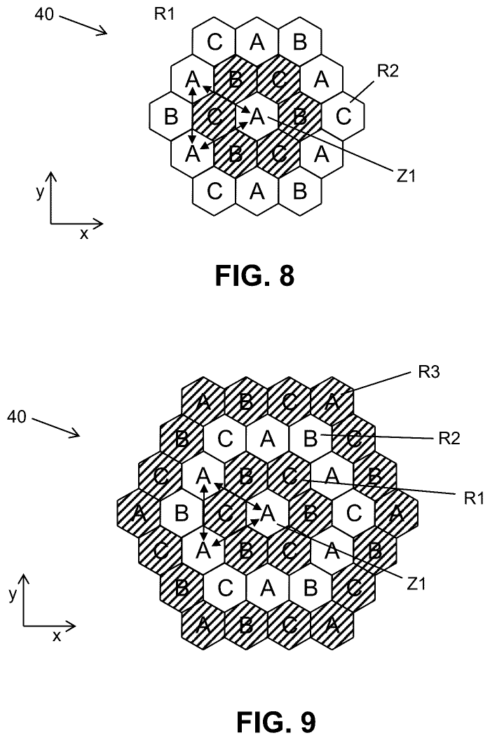

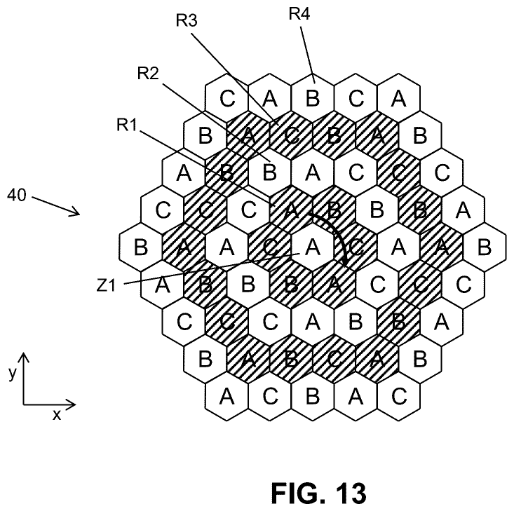

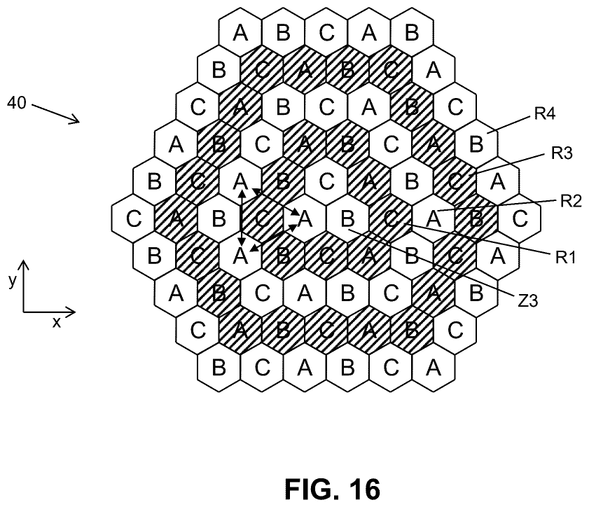

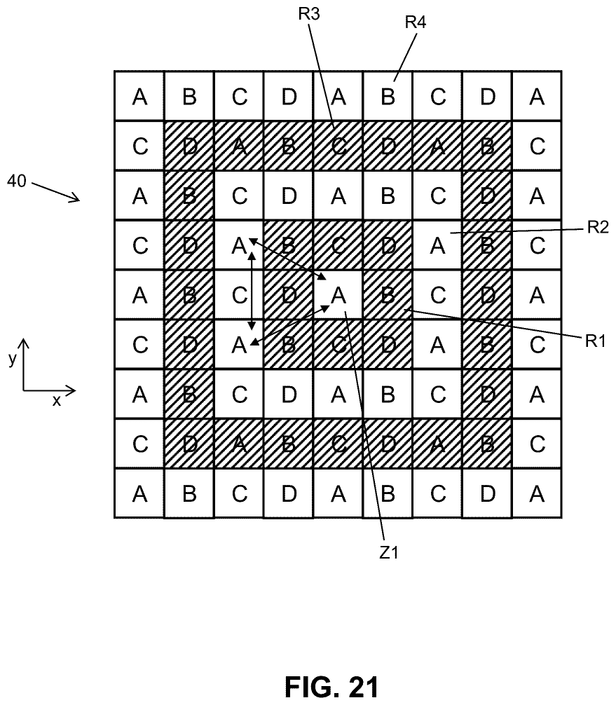

FIGS. 8 to 21: show exemplary embodiments of the lateral arrangement of lenses in lens groups in a multi-lens array for a light-field microscope according to the invention.

Identical and identically acting components are generally provided with the same reference signs in the figures.

One exemplary embodiment of a light-field microscope 100 according to the invention will be explained with reference to FIGS. 1 to 3 and 5. FIG. 1 schematically shows the light-field microscope 100 according to the invention. FIG. 2 schematically shows the arrangement of partial images T01 to T37 in a sensor plane 52 of a detector 50 of the light-field microscope 100. FIG. 3 shows details of the beam paths for various lenses of a multi-lens array and FIG. 5 shows further details of various lenses of the multi-lens array and their arrangement relative to the sensor plane 52.

According to the invention, the light-field microscope 100 initially comprises a light source 10, for example a laser or a laser module, for providing illumination light 12 and an illumination beam path for guiding the illumination light 12 into a sample region 2. In the exemplary embodiment shown, the illumination beam path comprises an excitation filter 13, a main beam splitter 14 and a microscope objective 20. At least some of the illumination light 12 is initially transmitted through the excitation filter 13 and subsequently reflected off the main beam splitter 14, typically a dichroic beam splitter, in the direction of the microscope objective 20, which guides the illumination light 12 into the sample space 2, in particular into a focal plane 16 of the microscope objective 20.

A sample 1, for example a biological preparation, is arranged in the sample region 2 and, for example, possibly accommodated in an embedding medium and arranged on a sample carrier. In the exemplary embodiment shown, an xyz-displacement stage 15 is present, by means of which the sample region 2 and hence the sample 1 can be moved in the direction of an optical axis 60 of the microscope objective 20, which coincides with the z-axis, and, independently thereof, in the two lateral coordinate directions x and y perpendicular to the z-axis. In FIG. 1, these coordinate directions are indicated by a coordinate system. The displacement device 15 serves to set a desired relative position between the sample 1 and the microscope objective 20 for the purpose of recording an image data set.

To detect detection light 17 emitted by the sample 1, especially as a consequence of the latter being irradiated by the illumination light 12, the light-field microscope 100 moreover comprises the two-dimensionally spatially resolving detector 50, for example a camera, and a detection beam path, which serves to guide the detection light 17 onto the detector 50. The detection light 17 can be in particular fluorescence from dye molecules used to prepare the sample 1. According to the invention, the detection beam path comprises the microscope objective 20 and a multi-lens array 40, the latter being arranged in a plane 34 optically conjugate to a back focal plane 22 of the microscope objective 20, hence in a pupil plane, in the exemplary embodiment shown. For example, the detector 50 can be realized by a CCD camera, a CMOS camera or a SPAD camera.

In the exemplary embodiment illustrated in FIG. 1, the detection beam path furthermore comprises the main beam splitter 14, an emission filter 18, a tube lens 24, which realizes a first lens of a relay optics unit 32, and a further lens 30, which realizes a second lens of the relay optics unit 32. The main beam splitter 14 serves to prevent portions of the illumination light 12 from being transmitted in the direction of the detector 50. Further spectral conditioning of the detection light 17 to be detected by the detector 50 can be effected by the emission filter 18. The relay optics unit 32 forms an intermediate image plane 26 in which a field stop 28 serving to avoid an overlap of partial images in a sensor plane 52 of the detector 50 is arranged in the exemplary embodiment illustrated. The field stop 28 realizes the stop device present according to the invention for preventing crosstalk between detection paths belonging to different lenses of the multi-lens array 40. In the exemplary embodiment shown, the sensor plane 52 of the detector 50 is situated in an intermediate image plane, and consequently in a plane optically conjugate to the focal plane 16 of the microscope objective 20 and to the intermediate image plane 26.

FIG. 2 shows an exemplary illustration of partial images T01 to T37, which are generated by a multi-lens array 40 with 37 singlet lenses, in the sensor plane 52 of the detector 50. In the example in FIG. 1, a central lens 42, the optical axis of which coincides with the optical axis 60 of the microscope objective 20, is located on the optical axis 60 of the detection beam path. The partial image T01 in the sensor plane 52 is generated by this central lens 42.

The arrangement of a light-field microscope 100 which is illustrated in FIG. 1 and in which the multi-lens array 40 is arranged in the plane 34 optically conjugate to the back focal plane 22 of the microscope objective 20 is also referred to as a Fourier light-field microscope. This arrangement of the multi-lens array 40 allows the partial images T01 to T37 measured by the detector 50 to be assigned to emission angles, which can be plenoptically combined by calculation in the example of fluorescence imaging shown here. The totality of the partial images T01, . . . , T37 of the sample 1 generated by one recording is referred to as an image data set.

According to the invention, the control unit 90 serves to evaluate measurement data from the detector 50 and can be implemented by a PC, for example. In the example in FIG. 1, the control unit 90 is also configured for controlling the displacement device 15 and the light source 10.

According to the invention, each lens of the multi-lens array 40 belongs to exactly one of at least two lens groups, wherein each lens group has at least three lenses and wherein the lenses from each lens group are arranged distributed over a surface of the multi-lens array 40. Examples of lens groups A, B, C, D, E and of the distribution of the lenses of these lens groups will be described below with reference to FIGS. 8 to 21.

According to the invention, detector-side focal points of lenses of the same lens group lie at the same position in the axial direction z relative to a sensor surface 52 of the detector 50 at the location of the relevant lens, and detector-side focal points of lenses from different lens groups lie at different positions in the axial direction z relative to the sensor surface of the detector 50 at the location of the relevant lens. Examples thereof will be described below with reference to FIGS. 5 to 7.

Some exemplary beam paths for the light-field microscope 100 according to the invention will be explained with reference to FIG. 3. FIG. 3 firstly schematically shows the sample 1, the microscope objective 20, the relay optics unit with the lenses 24, 30, and the detector 50 with a sensor plane 52. The multi-lens array 40 is illustrated by way of example with seven lenses in FIG. 3. For the central lens 42, the optical axis of which coincides with the optical axis 60 of the microscope objective 20, and for a lens 41 located at the left edge and a lens 43 located at the right edge, parts of the beam paths are illustrated in each case. The lens 41 belongs to a first lens group, the lens 42 belongs to a second lens group, and the lens 43 belongs to a third lens group.

In the example shown, all the lenses of the multi-lens array 40, hence also the lenses 41, 42, 43, are arranged at the same distance from the sensor plane 52 of the detector 50. The sensor surface 52 forms a plane surface arranged perpendicular to the optical axis 60.

In order to realize the feature according to the invention that the detector-side focal points of lenses which lie at different positions in relation to different lens groups in the axial direction z relative to the sensor surface 52 of the detector 50 at the location of the relevant lens, the lenses 41, 42, 43 each have different focal lengths. That is illustrated schematically in FIG. 5. FIG. 5 schematically shows the arrangement of the lenses 41, 42, 43 in the same axial plane z1=z2=z3, which is at a distance d from the sensor plane 52. It furthermore shows that the lens 41 has a focal length f1, which is greater than the distance d and is additionally greater than a focal length f2 of the lens 42. In the example shown, the focal length of the lens 42 is equal to the distance d and greater than a focal length f3 of the lens 43.

All lenses of the multi-lens array 40, including those not shown in FIG. 5, are arranged at the same distance from the sensor plane 52 of the detector 50. Further lenses of the first lens group, to which the lens 41 belongs, are not shown in FIG. 5. They have the same focal length f1 as the lens 41. Likewise, further lenses—not shown in FIG. 5—of the second lens group, to which the lens 42 belongs, have the same focal length f2 as the lens 42. Finally, further lenses—not shown in FIG. 5—of the third lens group, to which the lens 43 belongs, also have the same focal length f3 as the lens 43.

Overall, this realizes the feature according to the invention that the detector-side focal points of lenses of the same lens group lie at the same position in the axial direction z relative to a sensor surface 52 of the detector 50 at the location of the relevant lens, and detector-side focal points of lenses from different lens groups lie at different positions in the axial direction z relative to the sensor surface of the detector 50 at the location of the relevant lens.

FIG. 3 does not illustrate the focal points of the lenses 41, 42, 43, but rather focus points 71, 72, 73 respectively belonging to the lenses 41, 42, 43 and lying on the sensor plane 52. The focus point 71 belonging to the lens 41 is generated by a beam that emanates in the sample 1 from a point 61 lying above the axial plane 16. The focus point 72 belonging to the lens 42 is generated by a beam that emanates in the sample 1 from a point 62 lying on the optical axis 60 and in the plane 16. Finally, the focus point 73 belonging to the lens 43 is generated by a beam that emanates in the sample 1 from a point 63 lying below the plane 16. As can be seen, the choice according to the invention of different focal lengths for the lenses 41, 42, 43 of the different lens groups enables the addressing of different axial planes in the sample 1.

FIG. 4 shows a variant of the exemplary embodiment from FIG. 3. Only the differences are described here. The exemplary embodiment in FIG. 4 differs from that in FIG. 3 firstly in that the relay optics unit with the lenses 24, 30 and the field stop 28 are not present and in that the multi-lens array 40 is arranged in the back focal plane 22 of the microscope objective 20.

In the exemplary embodiment in FIG. 4, the stop device present according to the invention is realized by a stop structure 29 with a plurality of tubular stops, which, as indicated schematically in FIG. 4, are arranged in each case between a lens of the multi-lens array 40 and the sensor plane 52. These tubular stops have the effect that, as intended, crosstalk between detection channels belonging to different lenses 41, 42, 43 of the multi-lens array 40 is avoided and that the partial images generated by the individual lenses of the multi-lens array 40 do not overlap in the sensor plane 52.

Further possibilities as to how the feature according to the invention concerning the different axial positions of detector-side focal points of lenses belonging to different lens groups can be realized will be explained with reference to FIGS. 6 and 7, where only the differences in comparison with FIG. 5 will be described in each case.

In the exemplary embodiment in FIG. 6, the sensor plane 52 is once again formed as a plane surface. Contrary to the example in FIG. 5, however, all lenses of the multi-lens array, in particular the lenses 41, 42, 43 illustrated in FIG. 6, each have the same focal length f1=f2=f3. The different axial positions of the detector-side focal points of the lenses 41, 42, 43 are realized in FIG. 6 by virtue of the fact that the lenses 41, 42, 43, as can be seen, are arranged axially offset and thus at different distances d1<d2<d3 from the sensor plane 52. The differences between the axial positions z1, z2, z3 of the lenses are suitably dimensioned in order that the desired different axial positions of the detector-side focal points can be realized. Further lenses of the first lens group, to which the lens 41 belongs, are not shown in FIG. 6. They are at the same distance d1 from the sensor plane 52 as the lens 41. Likewise, further lenses—not shown in FIG. 6—of the second lens group, to which the lens 42 belongs, are at the same distance d2 from the sensor plane 52 as the lens 42. Finally, further lenses—not shown in FIG. 3—of the third lens group, to which the lens 43 belongs, are also at the same distance d3 from the sensor plane 52 as the lens 43.

In the exemplary embodiment in FIG. 7, once again all the lenses of the multi-lens array, in particular the lenses 41, 42, 43 illustrated in FIG. 7, each have the same focal length f1=f2=f3 and, as in the exemplary embodiment in FIG. 5, are each arranged in the same axial plane. The different axial positions of the detector-side focal points of the lenses 41, 42, 43 are realized in FIG. 7 by virtue of the fact that the sensor surface 52, as illustrated, has a stepped structure. A difference in the height of the steps is suitably dimensioned in order that the desired different axial positions of the detector-side focal points can be realized.

Further lenses of the first lens group, to which the lens 41 belongs, are not shown in FIG. 7. The steps of the sensor surface 52 at locations where these lenses are located each have the same axial step height as for the lens 41. Likewise, further lenses of the second lens group, to which the lens 42 belongs, are not shown in FIG. 7. The steps of the sensor surface 52 at locations where these lenses are located each have the same axial step height as for the lens 42. Further lenses of the third lens group, to which the lens 43 belongs, are likewise not shown in FIG. 7. The steps of the sensor surface 52 at locations where these lenses are located each have the same axial step height as for the lens 43.

In the examples in FIGS. 6 and 7, too, this realizes the feature according to the invention that the detector-side focal points of lenses of the same lens group lie at the same position in the axial direction z relative to a sensor surface 52 of the detector 50 at the location of the relevant lens, and detector-side focal points of lenses from different lens groups lie at different positions in the axial direction z relative to the sensor surface of the detector 50 at the location of the relevant lens.

In association with FIGS. 8 to 21, exemplary embodiments for the arrangement of lenses of different lens groups will now be explained, which each realize the feature according to the invention that the lenses from each lens group are arranged distributed over the surface of the multi-lens array 40. FIGS. 8 to 21 each show schematic views in the direction of the negative z-axis of arrangements of lenses in multi-lens arrays 40.

In each of the exemplary embodiments in FIGS. 8 to 21, the multi-lens array 40 has a central region and a plurality of rings of lenses, each completely and concentrically enclosing the central region. Each further radially outwardly following ring completely encloses a respectively preceding inner ring. For example, in the example in FIG. 9, the outer ring R3 completely encloses the inwardly adjacent middle ring R2, which in turn completely encloses the innermost ring R1.

In each of the exemplary embodiments in FIGS. 8 to 21, each of the lenses of the multi-lens array 40 belongs in each case to exactly one of the rings of lenses.

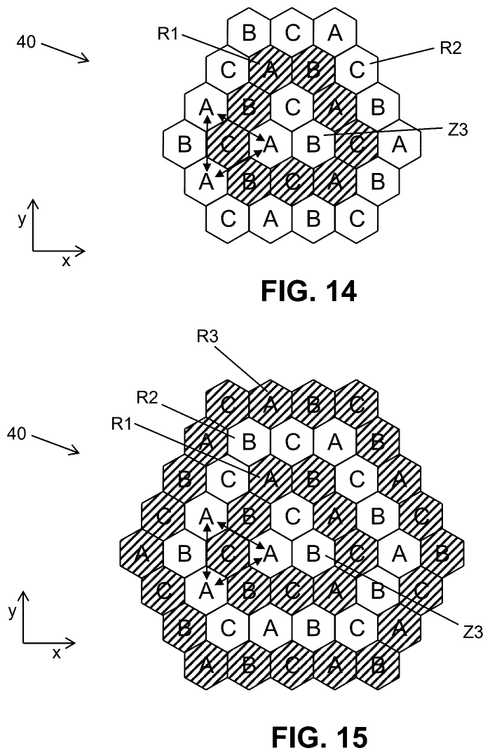

In the exemplary embodiments in FIGS. 8 to 13 and 17 to 21, the central region Z1 has in each case only a single lens, which is a lens of a lens group A in all the examples. In the exemplary embodiments in FIGS. 14 to 16, the central region Z3 has in each case three lenses, which are each lenses from lens groups A, B and C in these examples.

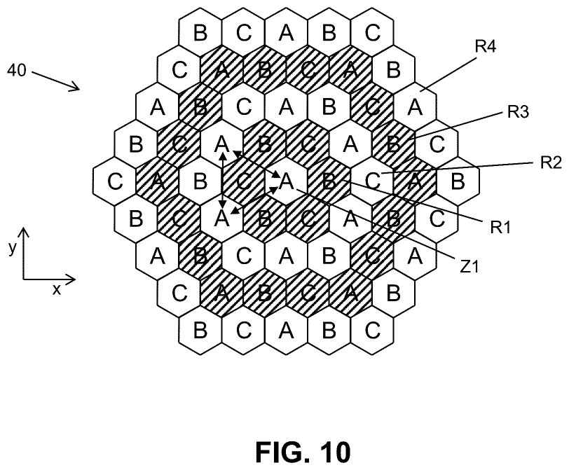

FIGS. 8, 11, 14 and 19 show exemplary embodiments with two rings R1 and R2 each. FIGS. 9, 12, 15, 17 and 20 show exemplary embodiments with three rings R1, R2 and R3 each. FIGS. 10, 13, 16, 18 and 21 show exemplary embodiments with four rings R1, R2, R3 and R4 each. In FIGS. 8 to 21, the rings R1 and R3 are illustrated in each case with hatching and the central region and the rings R2 and R4 are illustrated in each case without hatching.

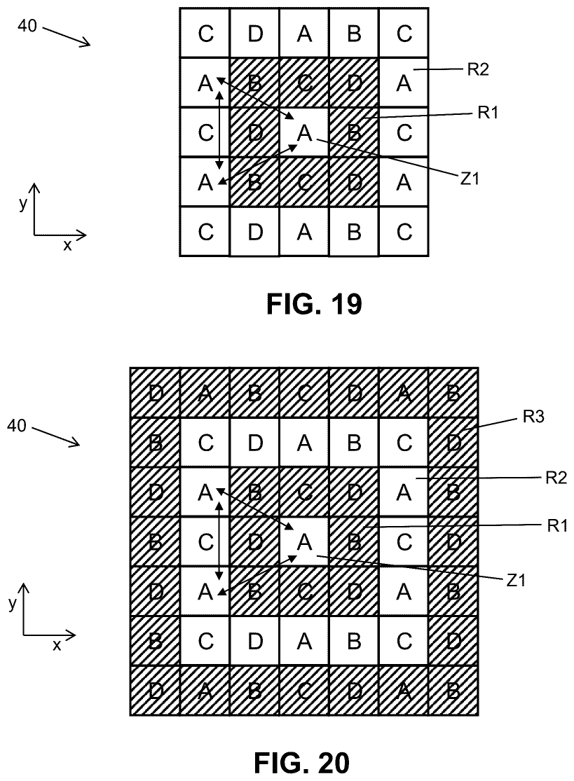

In the exemplary embodiments in FIGS. 8 to 18, the multi-lens array 40 has a hexagonal structure, that is to say that the intersection points between the optical axes of the lenses of the multi-lens array 40 and the plane of the drawing are located on a hexagonal grid. In the exemplary embodiments in FIGS. 19, 20 and 21, the intersection points between the optical axes of the lenses of the multi-lens array 40 and the plane of the drawing are located on a square grid.

In the exemplary embodiments in FIGS. 8 to 16, the multi-lens array 40 has in each case three lens groups A, B, C.

In the exemplary embodiments in FIGS. 8 to 10, the lenses of the lens groups A, B, C are each arranged distributed over the surface of the multi-lens array 40 in such a way that the distances between lenses from the same lens group are maximal in all three directions of the hexagonal grid. By way of example, that is indicated by three double-headed arrows for three lenses of the lens group A in FIGS. 8 to 10.

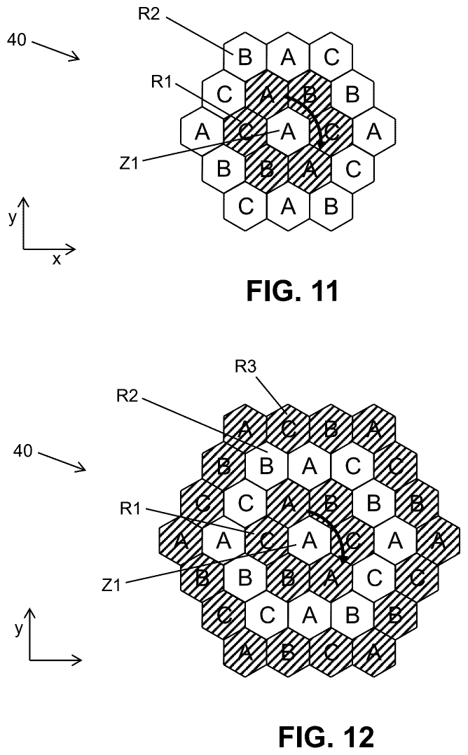

In the exemplary embodiments in FIGS. 11 to 13, the lenses of the lens groups A, B, C are each arranged distributed over the surface of the multi-lens array 40 in such a way that the distances between lenses from the same lens group in each of the rings of lenses are maximal in the circumferential direction. By way of example, that is indicated by a double-headed arrow curved in the circumferential direction for two lenses of the lens group A in the first ring R1 in FIGS. 11 to 13.

In the exemplary embodiments in FIGS. 14 to 16, in each of which the central region Z3 has three lenses, the lenses of the lens groups A, B, C once again, as in FIGS. 8 to 10, are each arranged distributed over the surface of the multi-lens array 40 in such a way that the distances between lenses from the same lens group are maximal in all three directions of the hexagonal grid. By way of example, that is indicated by three double-headed arrows for three lenses of the lens group A in FIGS. 14 to 16.

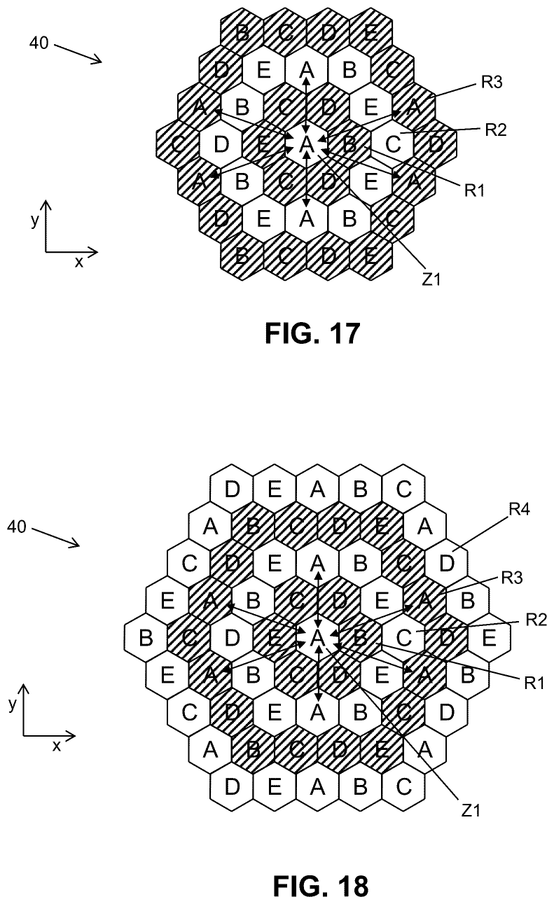

In the exemplary embodiments in FIGS. 17 and 18, the multi-lens array 40 has in each case five lens groups A, B, C, D, E. The lenses of the lens groups A, B, C, D, E are each arranged distributed over the surface of the multi-lens array 40 in such a way that the distances between lenses from the same lens group are maximal. By way of example, that is indicated by respective double-headed arrows for the central lens A, two lenses of the lens group A in the first ring R1 and four lenses of the lens group A in the second ring R2 in FIGS. 17 and 18.

In the exemplary embodiments in FIGS. 19 to 21, the multi-lens array 40 has in each case four lens groups A, B, C, D. In a manner similar to that in FIGS. 17 and 18, the lenses of the lens groups A, B, C, D are each arranged distributed over the surface of the multi-lens array 40 in such a way that the distances between lenses from the same lens group are maximal. By way of example, that is indicated by double-headed arrows in each case for the central lens A in FIGS. 19 to 21.

The variants in FIGS. 11 to 16 each realize the features that each ring has at least one lens from each lens group and that each ring has the same number of lenses from each lens group.

In all the exemplary embodiments in FIGS. 8 to 21, the feature is realized that each lens of the multi-lens array 40 has a maximum of one directly adjacent lens belonging to the same lens group.

The present invention provides novel light-field microscopy in which the axial range in which a good lateral resolution and a good axial resolution are achieved can be increased.

### LIST OF REFERENCE SIGNS

10 light source
12 illumination light
13 excitation filter
14 main colour splitter
15 xyz-displacement stage
16 sample plane
17 detection light
18 emission filter
20 microscope objective
22 back focal plane of the microscope objective 20
24 tube lens, first lens of the relay system 32
26 intermediate image plane
28 field stop, stop device
29 tube arrangement, stop device
30 lens, second lens of the relay optics unit 32
32 relay optics unit
34 plane optically conjugate to the back focal plane 22 of the microscope
objective 20, pupil plane
40 multi-lens array
41 lens of the multi-lens array, lens of a first lens group
42 central lens of the multi-lens array 40, lens of a second lens group
43 lens of the multi-lens array, lens of a third lens group
52 sensor surface of the detector 50
50 detector, camera
60 optical axis
61 focus volume belonging to the first lens 41
62 focus volume belonging to the second lens 42
63 focus volume belonging to the third lens 43
71 focus point belonging to the first lens 41 on the sensor plane 52
72 focus point belonging to the second lens 42 on the sensor plane 52
73 focus point belonging to the third lens 43 on the sensor plane 52
90 controller, PC
100 light-field microscope according to the invention
200 light-field microscope according to the invention
f1 focal length of the first lens
f2 focal length of the second lens
f3 focal length of the third lens
d1 distance between the first lens 41 and the sensor surface 52
d2 distance between the second lens 42 and the sensor surface 52
d3 distance between the third lens 43 and the sensor surface 52
T01, . . . , T37
partial images of an image data set
z1 axial position of the first lens 41
z2 axial position of the second lens 42
z3 axial position of the third lens 43
A lenses of a first lens group
B lenses of a second lens group
C lenses of a third lens group
D lenses of a fourth lens group
E lenses of a fifth lens group
R1 first ring of lenses
R2 second ring of lenses
R3 third ring of lenses
R4 fourth ring of lenses
Z1 central region of the multi-lens array, consisting of a single lens
Z3 central region of the multi-lens array, consisting of three lenses
X x-coordinate
y y-coordinate
Z z-coordinate

### REFERENCES

[1] DE 10 2022 128 078 A1
[2] Fanglin Linda Liu, et al.; “1 Fourier DiffuserScope: single-shot 3D Fourier light field microscopy with a diffuser”; Optics Express 28969, September 2020.

1. Light-field microscope comprising:
a light source for providing illumination light,
an illumination beam path for guiding the illumination light into a sample region,
a two-dimensionally spatially resolving detector for detecting detection light coming from a sample in the sample region,
a detection beam path with a microscope objective and a multi-lens array for guiding the detection light to the detector,
a stop device for preventing crosstalk between detection paths belonging to different lenses of the multi-lens array, and
a control unit for evaluating measurement data from the detector,
wherein
each lens of the multi-lens array belongs to exactly one of at least two lens groups,
each lens group has at least three lenses,
detector-side focal points of lenses of the same lens group lie at the same position in an axial direction relative to a sensor surface of the detector at the location of the relevant lens,
detector-side focal points of lenses from different lens groups lie at different positions in the axial direction relative to the sensor surface of the detector at the location of the relevant lens, and
the lenses from each lens group are arranged distributed over a surface of the multi-lens array.

2. Light-field microscope according to claim 1,
wherein
the multi-lens array has three to 25 lens groups.

3. Light-field microscope according to claim 1,
wherein
all lens groups have the same number of lenses or approximately the same number of lenses.

4. Light-field microscope according to claim 1,
wherein
all lenses of the same lens group each have the same nominal focal length, and
the lenses from different lens groups each have a different nominal focal length.

5. Light-field microscope according to claim 1,
wherein
an interval δf in which the focal lengths of the lenses of a lens group are located satisfies the inequality
$$δ f < 1. \cdot λ \cdot {F}^{2}$$
and/or
an interval Δf in which the focal lengths of all lenses of the multi-lens array are located satisfies the inequality,
$$0.3 \cdot λ \cdot {F}^{2} < Δ f < 1.5 \cdot λ \cdot {F}^{2}$$
wherein
λ is the wavelength of the detection light,
F is the f-number F=f₀/Ø,
f₀ is the average focal length of the lenses of the multi-lens array, and
Ø is the diameter of the multi-lens array.

6. Light-field microscope according to claim 1,
wherein
the lenses of the multi-lens array all have the same nominal focal length.

7. Light-field microscope according to claim 1,
wherein
lenses of the same lens group are each arranged at the same distance from the sensor surface of the detector, and
lenses belonging to different lens groups are arranged at respectively different distances from the sensor surface of the detector.

8. Light-field microscope according to claim 1,
wherein
the sensor surface of the detector has a plurality of steps,
wherein the steps at locations where lenses of the same lens group are located each have the same axial step height and
wherein the steps at locations where lenses from different lens groups are located each have a different axial step height.

9. Light-field microscope according to claim 1,
wherein
the positions of lenses of a lens group span a plane.

10. Light-field microscope according to claim 1,
wherein
the surface of the multi-lens array is subdividable into a number of at least three equally sized sectors which in an azimuthal direction are adjacent and non-overlapping, in such a way that at least one lens from each lens group is arranged in each of these sectors.

11. Light-field microscope according to claim 1,
wherein
the surface of the multi-lens array is subdividable into a central circular region and at least two adjacent and non-overlapping concentric annular regions each having the same radial extent, in such a way that at least one lens from each lens group is arranged in each of these regions.

12. Light-field microscope according to claim 1,
wherein
each lens of the multi-lens array has a maximum of one directly adjacent lens belonging to the same lens group.

13. Light-field microscope according to claim 1,
wherein
the lenses of a lens group are distributed over the surface of the multi-lens array in such a way that the distances between these lenses are maximal.

14. Light-field microscope according to claim 1,
wherein
the multi-lens array has a central region formed from one lens or from three or four lenses, and at least one ring of lenses that completely encloses the central region.

15. Light-field microscope according to claim 1,
wherein
the multi-lens array has a plurality of rings of lenses, each concentrically enclosing the central region.

16. Light-field microscope according to claim 15,
wherein
each further radially outwardly following ring completely encloses a respectively preceding inner ring, and
each of the lenses of the multi-lens array belongs to exactly one of the rings.

17. Light-field microscope according to claim 14,
wherein
the multi-lens array has two to nine, preferably two to four, rings.

18. Light-field microscope according to claim 14,
wherein
each ring has at least one lens from each lens group.

19. Light-field microscope according to claim 14,
wherein
the lenses of a lens group are arranged in each of the rings at a maximum distance in a circumferential direction of the ring.

20. Light-field microscope according to claim 14,
wherein
each ring has the same number of lenses from each lens group.

21. Light-field microscope according to claim 1,
wherein
the stop device has a field stop arranged in an intermediate image plane.

22. Light-field microscope according to claim 1,
wherein
in that the stop device has a stop structure a plurality of tubular stops, which is arranged between the multi-lens array and the detector.

23. Light-field microscope according to claim 1,
wherein
the multi-lens array is arranged in a plane optically conjugate to a back focal plane of the microscope objective or in the vicinity of such a plane.

24. Light-field microscope according to claim 1,
wherein
the control unit is configured to correct image distortions during the reconstruction of an image stack from a measured image data set, said image distortions being caused by the different positions of the focal points of lenses from different lens groups in the axial direction relative to the sensor surface of the detector at the location of the relevant lens.
